(19) United States
(12) Patent Application Publication
(10) Pub. No.: US 2014/0156419 A1
(43) Pub. Date: Jun. 5, 2014

(54) Method and device for presenting release information

(71) Applicant: TENCENT TECHNOLOGY (SHENZHEN) COMPANY LIMITED, Shenzhen, Guangdong (CN)

(72) Inventors: Qian Zhang, Shenzhen (CN); Xing Li, Shenzhen (CN); Lili Shen, Shenzhen (CN); Wei Xu, Shenzhen (CN); Ang Xu, Shenzhen (CN)

(73) Assignee: TENCENT TECHNOLOGY (SHENZHEN) COMPANY LIMITED, Shenzhen, Guangdong (CN)

(21) Appl. No.: 14/234,518

(22) PCT Filed: Mar. 21, 2013
(86) PCT No.: PCT/CN2013/073020

§ 371 Date: Jan. 23, 2014

(30) Foreign Application Priority Data
Apr. 13, 2012 (CN) 201210110478.0

(51) Int. Cl. G06Q 30/02

(52) U.S. Cl. CPC G06Q 30/0272
USPC 705/14.68

(57) ABSTRACT

It is described a method and device for presenting release information. The method includes that: a total exposure of release information on a day is acquired in real time; and a current ratio for presenting release information is calculated according to the total exposure of release information on the day, and release information is presented according to the current ratio for presenting release information. With a technical solution as described, it is possible to distribute exposure of the release information reasonably according to a ratio for presenting adjusted in real time, allowing uniform and reasonable presenting of the release information.

The present application claims the priority of CN application No. 201210110478.0, entitled “method and device for presenting release information” filed on Apr. 13, 2012 by TENCENT Technology (Beijing) Company Ltd., the disclosure of which is incorporated by reference herein in its entirety.

### TECHNICAL FIELD

The disclosure relates to information processing technology in the field of internet applications, and in particular to a method and device for presenting release information.

### BACKGROUND

An online video client device refers to an application for acquiring internet video information using a Point to Point (P2P) technology, and may be used for browsing a live television program or browsing video information shared by a net pal. At present, there is an increasing number of online video users. Therefore, if an online video is used to present release information (for example advertisements), the amount of release information will multiply in the upcoming two years.

The release information is mainly presented in several ways, such as presenting according to Cost Per Day (CPD), according to traffic, according to pageview, or the like. When presented in a video, the release information can only be presented in one way in a single presenting region. Hence, maximized benefit cannot be realized currently according to traffic of the release information, nor is the way in which the release information is presented can be adjusted in real time. The way in which the release information is presented needs to be adjusted if maximized benefit is desired.

At present, the release information may be presented in a video according to CPD or more commonly according to Cost Per Mille (CPM). There are two methods for presenting the release information according to CPM. With the first method, namely, a full-amount presenting method, the release information is continuously presented until the exposure allocated for a subscriber is fully used. With the second method, namely, a presenting-by-hour method, the exposure allocated for the subscriber is distributed over the hours of the day, and release information presenting is stopped when the exposure distributed to the hour is used out, and release information presenting is carried on once again starting from the next hour; such a cycle goes on until the exposure allocated for the subscriber is used out, and then release information presenting terminates.

FIG. 1 is a schematic diagram illustrating a curve of presenting release information with the full-amount presenting method in related art. As shown in FIG. 1, the exposure allocated for the subscriber is continuously consumed, and hence is virtually depleted around 12 O'clock, and no more release information is presented thereafter. It is clear that the exposure allocated for the subscriber fails to be spread reasonably over the 24 hours of the day. FIG. 2 is a schematic diagram illustrating a curve of presenting release information with the presenting-by-hour method in related art. As shown in FIG. 2, the exposure allocated for the subscriber is distributed over the 24 hours, and the exposure allocated to an hour is consumed as soon as possible in the hour, leading to more exposure at the beginning of an hour and less exposure at the end of the hour, thereby forming a sawtooth-shaped curve; thus, the release information fails to be presented in a uniform and reasonable way.

### SUMMARY

In view of this, it is desired that the disclosure provides a method and device for presenting release information, capable of distributing the exposure of the release information reasonably according to a ratio for presenting (the ratio for presenting may be adjusted in real time), allowing uniform and reasonable presenting of the release information.

To this end, a technical solution of the disclosure is implemented as follows.

An embodiment of the disclosure provides a method for presenting release information, including that:
a total exposure of release information on a day is acquired in real time;
a current ratio for presenting release information is calculated according to the total exposure of release information on the day; and
release information is presented according to the current ratio for presenting release information.

In the method, the total exposure of release information on a day may be acquired in real time through the following way:
averaging out historical data to get a ratio of exposure of release information within an hour on the day in a presenting region, wherein the ratio of exposure of release information within the hour is a ratio of exposure of release information within the hour to total exposure of 24 hours of the day; and
acquiring the total exposure of release information on the day in real time according to the ratio of exposure of release information within the hour on the day.

In the method, the acquiring the total exposure of release information on the day in real time according to the ratio of exposure of release information within the hour on the day may be:
during a period from 0 O'clock to 1 O'clock, making the total exposure of release information on the day equal to an average value of total exposure of release information in the historical data;
during a particular hour after 1 O'clock, making the total exposure of release information on the day equal to a ratio of a sum of exposure of release information within respective hour on the day prior to the particular hour to a sum of ratios of exposure of release information within respective hour on the day prior to the particular hour.

In the method, the step where a current ratio for presenting release information is calculated according to the total exposure of release information on the day and release information is presented according to the current ratio for presenting release information, may be:
the current ratio for presenting the release information is calculated as X/Y where Y is the total exposure of release information on the day and X is remaining allocated exposure of release information to be presented on the day; and
the release information is presented according to the current ratio for presenting release information X/Y.

An embodiment of the disclosure further provides a device for presenting release information, including:
an acquiring unit configured to acquire a total exposure of release information on a day in real time;
a calculating unit configured to calculate a current ratio for presenting release information according to the total exposure of release information on the day acquired by the acquiring unit; and
a presenting unit configured to present release information according to the current ratio for presenting release information calculated by the calculating unit.

In the device, the acquiring unit may be configured to:
average out historical data to get a ratio of exposure of release information within an hour on the day in a presenting region, wherein the ratio of exposure of release information within the hour is a ratio of exposure of release information within the hour to total exposure of 24 hours of the day; and
acquire the total exposure of release information on the day in real time according to the ratio of exposure of release information within the hour on the day.

In the device, the acquiring unit may be configured to:
during a period from 0 O'clock to 1 O'clock, make the total exposure of release information on the day equal to an average value of total exposure of release information in the historical data; and
during a particular hour after 1 O'clock, make the total exposure of release information on the day equal to a ratio of a sum of exposure of release information within respective hour on the day prior to the particular hour to a sum of ratios of exposure of release information within respective hour on the day prior to the particular hour.

In the device, the calculating unit may be configured to calculate the current ratio for presenting release information as X/Y, wherein Y is the total exposure of release information on the day and X is remaining allocated exposure of release information to be presented on the day, and
the presenting unit may be configured to present the release information according to the current ratio for presenting release information X/Y.

An embodiment of the disclosure further provides a computer program product including program instructions which, when executed on a processor, cause the processor to carry out steps in the method.

An embodiment of the disclosure further provides a storage medium storing the computer program product.

With the method and device for presenting release information provided by the disclosure, a total exposure of release information on a day is acquired in real time, a current ratio for presenting release information is calculated according to the total exposure of release information on the day, and release information is presented according to the current ratio for presenting release information. Thus, the total exposure of release information on the day is calculated each hour, such that the total exposure of release information on the day may be adjusted in real time (adjusted every hour), and thus the current ratio for presenting release information may be adjusted in real time (adjusted every hour). Hence, it is possible to distribute exposure of the release information reasonably according to a ratio for presenting release information (which is adjusted in real time), and to distribute the presenting of the release information reasonably and uniformly, avoiding the problems in related art that the exposure is completely depleted during a certain period of time and that there is less exposure at the end of an hour.

### BRIEF DESCRIPTION OF THE DRAWINGS

FIG. 1 is a schematic diagram illustrating a curve of presenting release information with the full-amount presenting method in related art;

FIG. 2 is a schematic diagram illustrating a curve of presenting release information with the presenting-by-hour method in related art;

FIG. 3 is a flow chart illustrating a method for presenting release information according to an embodiment of the disclosure;

FIG. 4 is a schematic diagram illustrating a curve of presenting release information with the presenting-by-hour method according to an embodiment of the disclosure; and

FIG. 5 is a schematic diagram illustrating a structure of a device for presenting release information according to an embodiment of the disclosure.

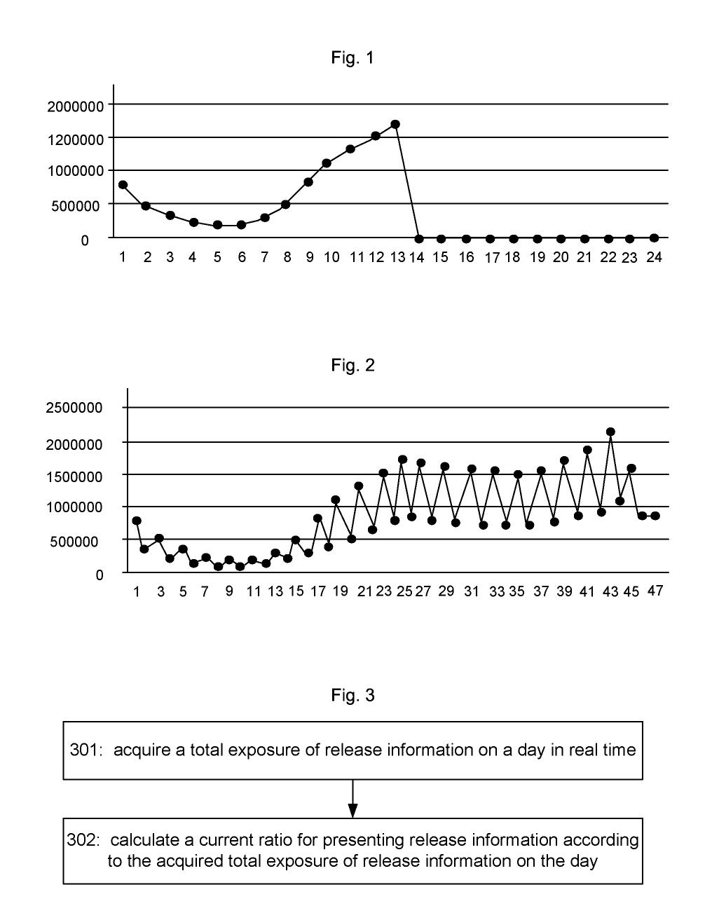

### DETAILED DESCRIPTION

The basic concept of the disclosure is that; a total exposure of release information on a day is acquired in real time; and a current ratio for presenting release information is calculated according to the total exposure of release information on the day, and release information is presented according to the current ratio for presenting release information.

The disclosure will be further illustrated in detail with reference to drawings and embodiments.

The disclosure provides a method for presenting release information. FIG. 3 is a flow chart illustrating a method for presenting release information according to an embodiment of the disclosure. As shown in FIG. 3, the method includes the steps as follows.

In step 301, a total exposure of release information on a day is acquired in real time.

Specifically, an average value of historical data is taken as a ratio of exposure of release information within a certain hour on the day in a presenting region. For example, the ratio of exposure of release information within a certain hour on the day may be an average value of ratios of exposure of release information within the certain hour in the last month. For example, the ratio of exposure during a period from 0 O'clock to 1 O'clock today may be the average value obtained by dividing a sum of ratios of exposure of release information during the period from 0 O'clock to 1 O'clock every day in the last month (containing 30 days, for example) by 30. The ratio of exposure of release information within a certain hour is a ratio of exposure of release information within the certain hour to total exposure of 24 hours of the day. For example, the exposure of release information during the period from 0 O'clock to 1 O'clock is 2% of the total exposure, the exposure of release information during the period from 1 O'clock to 2 O'clock is 1% of the total exposure, . . . , the exposure of release information during the period from 19 O'clock to 20 O'clock is 10% of the total exposure, . . . , the exposure of release information during the period from 23 O'clock to 24 O'clock is 3% of the total exposure, with the sum of the ratios of exposure of release information within each hour of the day being 100%.

After that, the total exposure of release information on the day in the presenting region is calculated in real time according to the ratio of exposure of release information within each hour on the day in the presenting region (that is, the total exposure of release information on the day is calculated every hour). Specifically, no exposure of release information can be obtained during the period from 0 O'clock to 1 O'clock, as no release information is presented in the presenting region during that time. Therefore, during the period from 0 O'clock to 1 O'clock, an average value of total historical exposure of release information is taken as the total exposure of release information on the day in the presenting region. For example, today (i.e. the day) is Monday, then the average value of total exposure of 24 hours in the presenting region over all Mondays in the last 5 weeks is adopted as the total exposure of release in the presenting region during the period from 0 O'clock to 1 O'clock of today. During each hour (for example, a designated hour) after 1 O'clock, the total exposure of release information within the designated hour on the day in the presenting region equals to the ratio of the sum of exposure of release information within respective hours before the designated hour on the day to a sum of ratios of exposure of release information within respective hours before the designated hour on the day.

For example, the ratio of exposure of release information within each hour of a day in the presenting region is shown in Table 1.

TABLE 1

| time (each hour of a day) | ratio of exposure |
|---|---|
| 0 | 4% |
| 1 | 3% |
| 2 | 3% |
| 3 | 2% |
| 4 | 2% |
| 5 | 1% |
| 6 | 1% |
| 7 | 3% |
| 8 | 5% |
| 9 | 4% |
| 10 | 4% |
| 11 | 5% |
| 12 | 6% |
| 13 | 3% |
| 14 | 4% |
| 15 | 5% |
| 16 | 3% |
| 17 | 4% |
| 18 | 7% |
| 19 | 8% |
| 20 | 9% |
| 21 | 5% |
| 22 | 5% |
| 23 | 4% |

If the sum of ratios of exposure of release information in the first 9 hours (the hours from numbering 0 to numbering 8) on the day is 24% and the sum of exposure of release information in the first 9 hours in the presenting region is of 2400 CPMs, then the total exposure of release information on the day in the presenting region is of 2400/24%=10000 CPMs.

In Step 302, a current ratio for presenting release information is calculated according to the acquired total exposure of release information on the day.

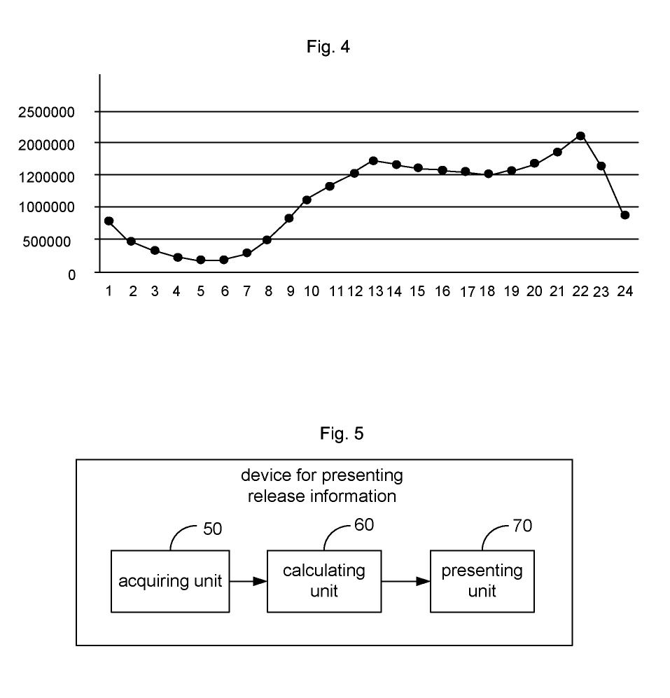

Specifically, assume that Y is the total exposure of release information on the day acquired in step 301 and that X is the remaining exposure of release information (allocated for a subscriber) which should to be presented in remaining hours of the day, then the current ratio for presenting release information in the presenting region is X/Y, and the release information is presented in the presenting region according to the current ratio for presenting X/Y. In this way, a smooth curve of presenting release information, as shown in FIG. 4, may be obtained and the exposure allocated for the subscriber may be distributed over 24 hours according to actual ratios of exposure calculated in real time. Meanwhile, it is ensured that the release information is not browsed every time a video is browsed, thus distributing total allocated exposure of release information throughout the day while ensuring subscriber experience effectively.

In addition, in a practical application, if the allocated exposure is not fully presented near the end of the day, such as at 22 O'clock or 23 O'clock, the calculated ratio for presenting may be multiplied by a certain coefficient to ensure that the actual exposure may reach the total allocated exposure, wherein the coefficient may be configured as needed.

In the disclosure, the total exposure of release information on the day is calculated each hour, such that the total exposure of release information on the day may be adjusted in real time (i.e. adjusted each hour), and thus the current ratio for presenting release information may be adjusted in real time (i.e. adjusted each hour), thereby avoiding the problems in related art that the exposure is completely depleted during a certain period of time and that there is less exposure at the end of an hour. Hence, it is possible to distribute exposure of the release information reasonably according to a ratio for presenting release information (which is adjusted in real time), allowing uniform and reasonable presenting of the release information.

In order to implement the aforementioned method, the disclosure further provides a device for presenting release information. In a practical application, the device may be located in a background server for publishing information. FIG. 5 is a schematic diagram illustrating a structure of a device for presenting release information according to an embodiment of the disclosure. As shown in FIG. 5, the device includes:
an acquiring unit 50 configured to acquire a total exposure of release information on a day in real time;
a calculating unit 60 configured to calculate a current ratio for presenting release information according to the total exposure of release information on the day acquired by the acquiring unit 50; and
a presenting unit 70 configured to present release information according to the current ratio for presenting release information calculated by the calculating unit 60.

The acquiring unit 50 may be configured to acquire the total exposure of release information on the day in real time through the following way:
averaging out historical data to get a ratio of exposure of release information within an hour on the day in a presenting region, wherein the ratio of exposure of release information within the hour is a ratio of exposure of release information within the hour to total exposure of 24 hours of the day; and
acquiring the total exposure of release information on the day in real time according to the ratio of exposure of release information within the hour on the day.

Here, the acquiring unit may be configured to acquire the total exposure of release information on the day in real time according to the ratio of exposure of release information within the hour on the day through the following way:
during a period from 0 O'clock to 1 O'clock, making the total exposure of release information on the day equal to an average value of total exposure of release information in the historical data;
during a particular hour after 1 O'clock, making the total exposure of release information on the day equal to a ratio of a sum of exposure of release information within respective hour on the day prior to the particular hour to a sum of ratios of exposure of release information within respective hour on the day prior to the particular hour.

The calculating unit 60 may be configured to calculate the current ratio for presenting release information according to the total exposure of release information on the day acquired by the acquiring unit through the following way:
calculating the current ratio for presenting release information as X/Y, where Y is the total exposure of release information on the day and X is remaining allocated exposure of release information which should to be presented within remaining hours of the day.

The presenting unit 70 may be configured to present the release information according to the current ratio for presenting release information X/Y.

When implemented in form of a software functional module and sold or used as an independent product, an integrated unit of an embodiment of the present disclosure may also be stored in a computer-readable storage medium. Based on such an understanding, the essential part (or a part of the technical solution of an embodiment of the present disclosure contributing to prior art) may appear in form of a software product, which software product is stored in storage media, and includes a number of instructions for allowing a computer equipment (such as a personal computer, a server, a network equipment, or the like) to execute all or part of the methods in various embodiments of the present disclosure. The storage media include various media that can store program codes, such as a mobile storage device, a Read-Only Memory (ROM), a Random Access Memory (RAM), a magnetic disk, a CD, and the like. Thus, an embodiment of the present disclosure is not limited to any specific combination of hardware and software.

What described are merely preferred embodiments of the present disclosure and are not intended to limit the scope of the present disclosure. Any modification, equivalent replacement, improvement, and the like made within the principle of the disclosure are included in the scope of the disclosure.

1. A method for presenting release information, comprising:
acquiring a total exposure of release information on a day in real time;
calculating a current ratio for presenting release information according to the total exposure of release information on the day; and
presenting the release information according to the current ratio for presenting release information,
wherein the calculating a current ratio for presenting release information according to the total exposure of release information on the day, and presenting release information according to the current ratio for presenting release information, comprises:
calculating the current ratio for presenting the release information as X/Y, wherein Y is the total exposure of release information on the day and X is remaining allocated exposure of release information to be presented on the day; and
presenting the release information according to the current ratio for presenting release information X/Y.

2. A method for presenting release information, comprising:
acquiring a total exposure of release information on a day in real time;
calculating a current ratio for presenting release information according to the total exposure of release information on the day; and
presenting the release information according to the current ratio for presenting release information,
wherein the acquiring a total exposure of release information on a day in real time, comprises:
averaging out historical data to get a ratio of exposure of release information within an hour on the day in a presenting region, wherein the ratio of exposure of release information within the hour is a ratio of exposure of release information within the hour to total exposure of 24 hours of the day; and
acquiring the total exposure of release information on the day in real time according to the ratio of exposure of release information within the hour on the day.

3. The method according to claim 2, wherein the acquiring the total exposure of release information on the day in real time according to the ratio of exposure of release information within the hour on the day, comprises:
during a period from 0 O'clock to 1 O'clock, making the total exposure of release information on the day equal to an average value of total exposure of release information in the historical data;
during a particular hour after 1 O'clock, making the total exposure of release information on the day equal to a ratio of a sum of exposure of release information within respective hour on the day prior to the particular hour to a sum of ratios of exposure of release information within respective hour on the day prior to the particular hour.

4. The method according to claim 3, wherein the calculating a current ratio for presenting release information according to the total exposure of release information on the day, and presenting release information according to the current ratio for presenting release information, comprises:
calculating the current ratio for presenting the release information as X/Y, wherein Y is the total exposure of release information on the day and X is remaining allocated exposure of release information to be presented on the day; and
presenting the release information according to the current ratio for presenting release information X/Y.

5. A device for presenting release information, comprising:
an acquiring unit configured to acquire a total exposure of release information on a day in real time;
a calculating unit configured to calculate a current ratio for presenting release information according to the total exposure of release information on the day acquired by the acquiring unit; and
a presenting unit configured to present release information according to the current ratio for presenting release information calculated by the calculating unit,
wherein the calculating unit is configured to calculate the current ratio for presenting release information as X/Y, wherein Y is the total exposure of release information on day and X is remaining allocated exposure of release information to be presented on the day, and
wherein the presenting unit is configured to present the release information according to the current ratio for presenting release information X/Y.

6. A device for presenting release information, comprising;
an acquiring unit configured to acquire a total exposure of release information on a day in real time;
a calculating unit configured to calculate a current ratio for presenting release information according to the total exposure of release information on the day acquired by the acquiring unit; and
a presenting unit configured to present release information according to the current ratio for presenting release information calculated by the calculating unit,
wherein the acquiring unit is configured to:
average out historical data to get a ratio of exposure of release information within an hour on the day in a presenting region, wherein the ratio of exposure of release information within the hour is a ratio of exposure of release information within the hour to total exposure of 24 hours of the day; and
acquire the total exposure of release information on the day in real time according to the ratio of exposure of release information within the hour on the day.

7. The device according to claim 6, wherein the acquiring unit is configured to:
during a period from 0 O'clock to 1 O'clock, make the total exposure of release information on the day equal to an average value of total exposure of release information in the historical data; and
during a particular hour after 1 O'clock, make the total exposure of release information on the day equal to a ratio of a sum of exposure of release information within respective hour on the day prior to the particular hour to a sum of ratios of exposure of release information within respective hour on the day prior to the particular hour.

8. The device according to claim 7,
wherein the calculating unit is configured to calculate the current ratio for presenting release information as X/Y, wherein Y is the total exposure of release information on the day and X is remaining allocated exposure of release information to be presented on the day, and
wherein the presenting unit is configured to present the release information according to the current ratio for presenting release information X/Y.

9. (canceled)

10. A storage medium storing a computer program product, which computer program product comprises program instructions which, when executed on a processor, cause the processor to carry out a method for presenting release information, the method comprising:
acquiring a total exposure of release information on a day in real time;
calculating a current ratio for presenting release information according to the total exposure of release information on the day; and
presenting the release information according to the current ratio for presenting release information,
wherein the calculating a current ratio for presenting release information according to the total exposure of release information on the day, and presenting release information according to the current ratio for presenting release information, comprises:
calculating the current ratio for presenting the release information as X/Y, wherein Y is the total exposure of release information on the day and X is remaining allocated exposure of release information to be presented on the day; and
presenting the release information according to the current ratio for presenting release information X/Y.
